(19) United States
(12) Patent Application Publication
(10) Pub. No.: US 2008/0172738 A1
(43) Pub. Date: Jul. 17, 2008

(54) Method for Detecting and Remediating Misleading Hyperlinks

(76) Inventors: Cary Lee Bates, Rochester, MN (US); James Edward Carey, Rochester, MN (US); Jason J. Illg, Rochester, MN (US)

Correspondence Address: IBM CORPORATION (SS/ROC);c/o STREETS & STEELE, 13831 NORTHWEST FREEWAY, SUITE 355, HOUSTON, TX, 77040, US

(21) Appl. No.: 11/622,082

(22) Filed: Jan. 11, 2007

(51) Int. Cl. G06F 11/00

(52) U.S. Cl. 726/22

(57) ABSTRACT

A method for verifying the validity of a hyperlink, and determining whether the domain name of the website that the user is directed to is valid. In one embodiment, the method identifies a hyperlink, a URL within the hyperlink and a domain name within the URL. The identified domain name is then assigned a page rank parameter. If the page rank parameter is below a threshold value, then the method compares the identified domain name to a list of well-known or high page rank domain names. A similarity parameter is then assigned to the identified domain name to indicate if the hyperlink is misleading. If the link is misleading, the method may implement some configurable remedial action, such as alerting the user or disabling the hyperlink.

### BACKGROUND OF THE INVENTION

1. Field of the Invention

The present invention relates to methods of preventing cyber-crimes. More specifically, the present invention relates to detecting security threats caused by misleading hyperlinks.

2. Description of the Related Art

Over a billion people use the Internet on a regular basis. The most universally used applications available over the Internet are email and instant messaging. These applications are widely used by commercial entities because of the low expense for sending messages to many recipients.

Many users of the Internet are not computer savvy and have little knowledge of the vulnerabilities of personal and confidential information stored on their personal computers. These users are attractive prey for confidence artists. The same factors that make email and instant messaging attractive to business and to consumers make these applications attractive for scammers and confidence artists. A scammer can inexpensively design and deliver messages to a very large number of consumers. These conditions have led to the spread of an Internet scam that has become known as “phishing.”

Phishing is a term that refers to criminal activity on the Internet that is designed to manipulate people into divulging their confidential information. Phishing, a deliberate misspelling of “fishing,” refers to a confidence artist's attempt to entice unsuspecting consumers into divulging their personal information, such as credit card numbers or passwords used to access on-line accounts. A “phisher” may design and send emails or instant messages that are deliberately made to resemble emails or messages from commercial entities that rely on the Internet for transacting business. The fraudulent emails or messages are designed to appear as if they are from a legitimate source familiar to a large number of consumers, such as a commonly used website or large bank. The phisher will generally ask the recipient to respond to the email or message by providing confidential and personal information, such as a bank account number, credit card number, social security number, user ID or the recipient's password to an on-line account.

More sophisticated phishers cleverly design the email or message to induce the recipient to actually want to divulge personal information over the Internet. For example, the phisher's message may contain a selectable hyperlink that delivers the recipient to a website that has been created specifically to facilitate the phishing scam. Frequently, the phisher's email message may provide information that is alarming to the recipient to induce the recipient to select the hyperlink in order to fix a problem. For example, the phisher's message may warn the recipient of “suspicious activity,” such as an attempt to use the recipient's on-line account without the proper password, and it may ask the recipient to use a provided hyperlink to visit the website and log in to the account or otherwise to provide personal information to verify or change a password. Ironically, many phishing scams operate by falsely alerting the recipient to a security threat to the recipient's on-line account in order to obtain the recipient's personal information.

The hyperlink that is provided to the recipient in the email message may induce the recipient to select the hyperlink by appearing to deliver the recipient to the website related to the recipient's on-line account. However, a hyperlink provided to the unsuspecting recipient in an electronic document may be made to appear however the sender wishes. For example, a display name or text within the message may be displayed as “www.yahoo.com” to appear as an actual hyperlink to a familiar website, but the text may actually include an embedded link that will direct the recipient's browser to a different website set up by the phisher to facilitate the scam. The website to which the recipient is delivered by selecting the hyperlink may strongly resemble a familiar and authentic website that corresponds to the destination that the hyperlink appeared to offer to the recipient. Unwary recipients may not understand how hyperlinks operate or may not even know that hyperlinks can be manipulated to deliver the recipient to a website other than the website that appears in the text. A recipient arriving at the phony website will be asked to verify passwords or account numbers, or to input sensitive personal information that is captured and misused by the phisher.

One particularly clever method of phishing is to warn the recipient in an email message or an instant message of a problem with their on-line account. For example, an email may be designed to appear to have been sent to the recipient by a bank, a credit card company or other similar entity with which the recipient may do business, and to warn the recipient of “suspicious activity” on their account. The recipient selects the hyperlink in an effort to prevent fraud or identity theft, is actually directed to the phony website created by the phisher to facilitate the scam, and attempts to use this website to verify the status of the account. The website usually appears to the unsuspecting recipient as the actual website for the bank, the credit card company or business maintaining the recipient's on-line account, and the phony website is designed to receive and record the recipient's personal information, such as account numbers, passwords, or other personal information which may be misused by the phisher.

Therefore, there is a need for a method to detect misleading hyperlinks contained within electronic documents, such as email messages and instant messages. Also, there is a need to warn or protect the recipient of electronic documents from phishing scams that utilize misleading hyperlinks delivered to the recipient by email or instant messaging.

### SUMMARY OF THE INVENTION

The present invention provides a method for verifying the authenticity of a hyperlink, and for determining whether the domain name within the hyperlink is likely to be related to a phishing scam. In one embodiment of the present invention, the method comprises the steps of identifying a hyperlink within an electronic document, identifying the URL of the hyperlink, identifying a domain name within the URL, assigning a page rank parameter to the domain name, determining whether the page rank parameter assigned to the domain name is greater than a threshold page rank value, and analyzing the similarity of the identified domain name to a list of well-known or high page rank domain names. One embodiment of the method includes the step of analyzing the domain name for substituted characters, inserted or omitted plurals, redundant characters or other character insertions, substitutions or omissions, relative to domain names of well-known or high page rank websites that are designed to make the domain name appear to the recipient to be a legitimate domain name. This method may also include assigning a similarity parameter to the domain name, where the similarity parameter reflects the extent to which the domain name is designed to appear similar to one of a list of well-known domain names. The method may also include analyzing the similarity parameter and the page rank parameter, then using an algorithm to determine if the hyperlink is misleading. The method may optionally further comprise the step of notifying the recipient of the misleading hyperlink before the document containing the misleading hyperlink is opened. The method may also automatically disable the misleading hyperlink detected in the document to prevent the hyperlink from being used by the recipient.

### BRIEF DESCRIPTION OF THE DRAWINGS

FIG. 1 is a flowchart representing a method for verifying the validity of a hyperlink contained within an electronic document.

FIG. 2 is a quadrant graph illustrating the categorization of hyperlinks to determine the likelihood that a hyperlink contained within an electronic document is misleading.

FIG. 3 is a schematic diagram of a computer system that is capable of receiving and opening electronic documents, such as an email message, and performing a method of ensuring the validity of a URL link.

### DETAILED DESCRIPTION OF PREFERRED EMBODIMENTS

The present invention provides a method for verifying the validity of a hyperlink contained within an electronic document, and for determining whether the domain name of the website contained within the hyperlink is likely to be created for fraudulent purposes. A hyperlink appearing within an electronic document is typically readily distinguishable from the surrounding text. Hyperlinks are commonly displayed in electronic documents using a highly visible font color or font size, and by underlining the hyperlink. A hyperlink that appears in an electronic document generally has several components. The main hyperlink components of interest in the present invention are the link label and the uniform resource locator (URL) that encodes the link destination.

Although a URL can be copied directly into an electronic document, the URL of an embedded hyperlink is not displayed. The link label is the character string that the electronic document displays to a user on a computer monitor. The link label may comprise any desired character string, or it may be a graphic, such as a photo, emblem or icon, that the user may select to visit the link destination. The link destination is encoded as a uniform resource locator (URL), sometimes referred to as the uniform resource identifier (URI). While the URI and URL are slightly different in their meaning, common usage does not differentiate between these terms, and the following disclosure will refer to the URL. The URL identifies a web resource, such as a website, available over the Internet. The URL provides the address of the web resource that a web browser will access when the hyperlink is selected by the recipient. The URL also provides the protocol used to retrieve the resource. A significant contributing factor to the problem of phishing is that the URL encoding the link destination is typically hidden in HTML code, and the recipient of the electronic document is not shown the URL for the website that will be visited by selecting the hyperlink.

The method of the present invention comprises the step of identifying a hyperlink within an electronic document. The electronic document may comprise an email, an instant message, a web page, a word processing file, a graphic presentation, a portable document format (PDF) file, or any electronic document or file capable of containing and displaying a hyperlink to the recipient. Hyperlinks can be identified by parsing the document and looking for specific patterns that indicate a URL, such as looking for “http”, “www”, or “.com”. A hyperlink may also be identified by searching the HTML source code for an anchor tag having a hypertext reference (HREF) or by any other means that can detect the presence of a hyperlink within an electronic document. For example, the HTML code to establish a hyperlink may include the following:

<a href=“http://antivirus.about.com”>http://www.ebay.com</a>.

Having identified a hyperlink, it is then possible to further analyze the HTML code to identify the URL that encodes the link destination of that hyperlink. In most instances, especially in phishing, the URL is not displayed within the text or graphic of the hyperlink. Rather, a link label that may or may not bear any relationship to the URL is displayed. Therefore, the HTML or other source code must be accessed in order to determine the actual URL. The link destination will most likely be a specific web page on a website. For example, selecting a hyperlink having a link to http://www.ibm.com/info/page.htm will cause a browser to display a web page, page.htm, which resides in the info directory on the website associated with the domain name www.ibm.com.

The domain name is identified by parsing the domain name, such as www.ibm.com, from the remainder of the URL. Alternatively, when the hyperlink includes an IP address, such as 142.118.0.11, rather than a domain name, the IP address may be identified instead.

The method further comprises the step of assigning a page rank parameter to the domain name. The page rank parameter aids in determining whether the link will access a valid website or webpage. This determination is based on the assumption that webpages receiving a significant amount of Internet “traffic” or visits are generally valid, and need not be further analyzed. The page rank parameter may be summarily determinable by comparing the domain name identified within the hyperlink to a list of well-known or high page rank domain names. If the domain name within the hyperlink matches a domain name having a known page rank, then a default page rank parameter value may be assigned to the identified domain name. For example, the list of well-known and high page rank domain names would include, for example, www.ibm.com, www.amazon.com, www.yahoo.com and www.whitehouse.gov, all of which are assigned high default page rank parameters. Popular search engines, such as Yahoo! or Google, maintain and publish statistics that allow individual websites to be ranked by various measures. Therefore, the page rank parameter for a given domain name may be determined by retrieving a page rank from a search engine. Alternately, the step may comprise accessing a list of the most widely known domain names from an organization that tracks Internet usage and publishes the results of its findings. Another alternative is to maintain a list of subscribing corporate and organizational websites with statistics for domain name usage.

The list may also include domain names that are “well-known” because they have been identified as fraudulent or misleading, and these domain names are assigned unfavorable page rank parameters. If the domain name identified within the hyperlink matches a misleading domain name on the well-known list, then a page rank parameter corresponding to the degree of threat is assigned and the method skips directly to the step of taking remedial action, which may comprise warning the recipient or disabling or blocking the hyperlink in accordance with the assessed level of the security threat. However, if the domain name identified within the hyperlink does not match a known domain name on the list, the method may assign a page rank parameter to the domain name reflecting the assessed level of the security threat.

If the configured page rank parameter falls below a threshold value, then the method may further comprise the steps of comparing the identified domain name and/or the link label to a list of well-known domain names, and assigning a similarity parameter to the identified domain name and/or the link label. For example, if the domain name is deceptively similar to, but not identical to, a domain name that is frequently-visited and/or widely-known to a large number of consumers, then the assigned similarity parameter will be high. However, if the identified domain name is not similar to any frequently visited and/or widely known domain name, then the similarity parameter will be low. This step is designed to identify a security threat by domain names or link labels that are deceptively similar to known domain names, such as www.paypals.com (deceptively similar to www.paypal.com), www.YAH00.com (deceptively similar to www.yahoo.com) and www.wells-fargo.com (deceptively similar to www.wellsfargo.com). It is generally more important to identify a misleading URL than a misleading link label, because the URL determines the website that will be accessed by the browser upon selecting the link. Still, it can be quite useful to identify a misleading link label, since user may decide whether or not to select the link based upon the link label.

The step of assigning a similarity parameter may include an analysis of the substitution of similar characters. For example, in English, the substitution of zero (0) for the uppercase letter “O”, and the substitution of the digit one (1) for the lowercase letter “l” results in a word that appears deceptively similar to the original, correctly spelled word. In the step of assigning a similarity parameter, the presence of substituted characters that tend to make the label appear to state a frequently visited or widely known domain name in a deceptively misleading manner will increase the threat and the similarity parameter. Another consideration may be to search for the usage of an improperly inserted “s” or “es” to pluralize a word, a minor change that may go unnoticed by the recipient. For example, www.paypals.com includes an inserted letter “s,” and may be used to misdirect a recipient having an on-line account at www.paypal.com. This step may include searching for the inclusion or exclusion of repetitive characters, for example www.busines.com or www.bussiness.com, instead of the authentic website at www.business.com. Alternatively, characters in different languages or fonts may be interspersed within the link label. For example, the Cyrillic letter “a” is displayed identically to the Latin letter “a”. However, a computer may differentiate between these two characters and read the character strings differently.

If the page rank parameter of the domain name is below a threshold page rank value, then the website associated with the domain name has a low traffic volume and is not likely to be a frequently visited website. If the page rank parameter is above the threshold page rank value, then the hyperlink likely delivers the recipient to a safe website, and the method comprises no further steps. Alternatively, if the page rank parameter falls below the threshold value, then the website associated with the domain name has a low traffic volume and is not likely to be a frequently visited website. In this case, a subsequent step of the method determines if the similarity parameter is above an alarm threshold.

If the similarity parameter of an identified domain name is above a similarity threshold value, then the domain name is very similar to, but not identical to, that of a well-known domain name and the method may further comprise the step of alerting the recipient of the electronic document to the probability of phishing. For example, the method may automatically cause a text box to be displayed immediately adjacent to the hyperlink within the electronic document alerting the recipient that the hyperlink may be misleading. The text box may include an estimated probability that the hyperlink is illegitimate. Alternatively, the display may comprise a rating on a configurable scale, a color-coded flag, or other visual and/or audio means designed to distinguish a safe hyperlink from a misleading hyperlink.

The method might also comprise a step of automatically disabling a hyperlink determined to be misleading. Disabling the hyperlink may be performed in addition to, or instead of, displaying a warning to the recipient, disabling the recipient's messaging account from receiving further hyperlink-containing messages from the sender of the electronic document, notify a network administrator, or any other configurable remedial action designed to protect the recipient from further misleading hyperlinks.

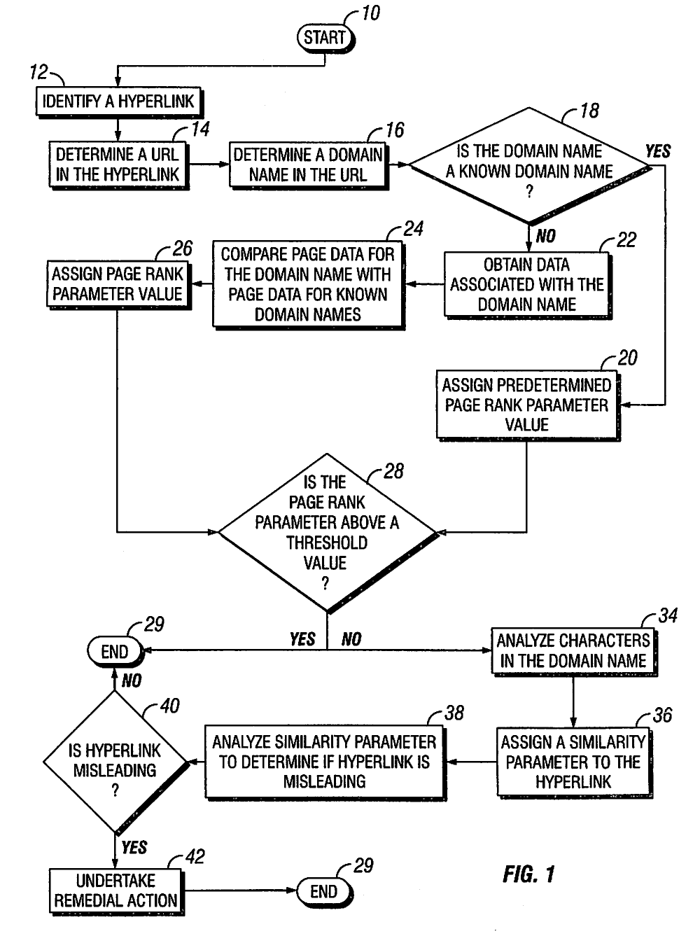

FIG. 1 is a high-level flowchart depicting one embodiment of the present invention. In step 10, the method begins. The method may be implemented in response to receiving an email or instant message, accessing a file, manually initiating the method, or any other configured condition.

In step 12, a hyperlink is identified. The hyperlink may be identified within an electronic document by scanning the content of the document, email, message and attached files. The electronic document may be scanned to determine the presence of a link. In this step, any scripts, including hypertext markup language (HTML), JAVA script, XML script, and others may be identified and scanned to determine if a hyperlink is present.

In step 14, the URL of the hyperlink and/or the link label is identified. The URL provides the address for a web page or web address that will be accessed by a browser upon selecting the hyperlink. In step 16, the domain name within the URL is identified. The domain name may be a parsed portion of the full URL.

In step 18, the domain name of the URL is compared to a list of domain names having a known safety level or known page rank. The list of known domain names may be obtained using resources on the Internet, maintained locally on the recipient's computer, or accessed from a remote computer. If the domain name in the hyperlink is determined to correspond to a known domain name, then in step 20, a predetermined page rank parameter associated with the known domain name is assigned to the identified domain name or the hyperlink itself. However, if the identified domain name does not appear on the list of well-known or high page rank domain names, then in step 22, the page rank value for the website associated with the domain name in the link destination is assessed using other resources on the Internet. Specifically, the page rank value for a destination, such as a website, may be determined by obtaining data from certain websites, such as the search engines www.yahoo.com or www.google.com, or any other source of web page activity or rankings. In step 24, the determined page rank value associated with the domain name is compared to the page rank value associated with known domain names. In step 26, a page rank parameter is assigned to the hyperlink based on the comparison. In a non-limiting example, the page rank parameter may be some configurable function of the relationship between the number of web pages that reference the hyperlinked website and the number of web pages that reference known domain names. Most preferably, the page rank parameter is the website's rank within an ordered list of high page rank websites. Alternatively, the page rank parameter may be a measure of the number of references to the hyperlinked website or specific web page.

In step 28, the assigned page rank parameter (either from step 20 or step 26) for the domain name of the URL is compared to a configurable threshold value and, if the page rank parameter is above the threshold value, then in step 29, the assessment terminates and the hyperlink is left enabled and available for selection by the recipient without warnings or notifications. However, if the page rank parameter of the identified domain name is below the threshold value, then in step 34, the characters within the URL of the hyperlink are analyzed for character repetition, character substitution or other content indicating an intent to mislead the recipient. The analysis may include analyzing the URL of the hyperlink for substituted or replaced characters, such as replacing the digit one (1) for the lowercase letter L, for duplicate letters where there should be none, for omitted letters, plurals, omitted plurals, and any other misleading characters in the label. The characters analyzed may differ based upon the language of the document. In step 36, a similarity parameter is assigned to the URL based on the results of the similarity analysis described above. This similarity parameter indicates whether the URL contains a domain name that is very similar to, but slightly different from, a well-known or high page rank domain name.

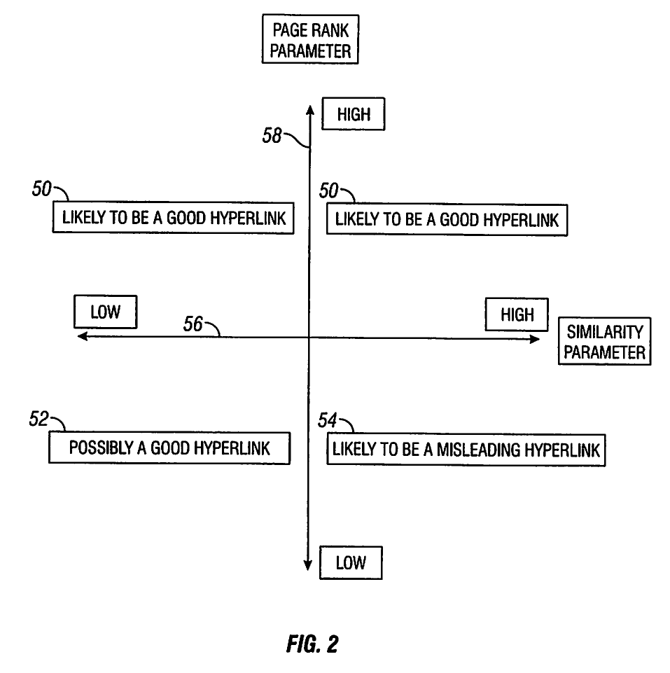

In step 38, the similarity parameter for the domain name is analyzed to determine if the hyperlink is misleading. A more detailed discussion of this determination is presented in connection with FIG. 2, a quadrant graph illustrating the likelihood that a hyperlink is misleading. The analysis of similarity parameter of the domain name is intended to determine when the identified domain name is suggestive of a well-known or high page rank domain name (high similarity), but the page rank parameter of the actual domain name within the URL indicates that it is not a well-known domain name (low page rank in step 28).

If the hyperlink was not found to be misleading in step 38, then in step 40, the method moves to step 29 and terminates until another hyperlink requires analysis (starting over at step 10). If the hyperlink is found to be misleading in step 38, then in step 40, the method moves to step 42 and takes remedial action. This remedial action may include merely notifying the recipient that the hyperlink contained within the electronic document may be misleading, disabling the hyperlink, blocking the address from which the electronic document was sent, or any other action.

FIG. 2 is a quadrant graph illustrating the categorization of hyperlinks made by the method of the present invention to determine the likelihood that a hyperlink contained within an electronic document is misleading. Domain names with a high page rank parameter will necessarily have a high traffic volume. This indicates that Internet users visit frequently, and fraudulent or misleading activity is unlikely. An assigned page rank parameter substantially above a threshold value indicates that the hyperlink is likely to be secure 50.

A high assigned page rank parameter for a domain name combined with either a low or a high similarity parameter for the domain name indicates that the hyperlink is likely to be valid and secure 50. Although the page rank value for the website associated with the domain name is low, the identified domain name is not confusingly similar to a frequently visited domain name. Accordingly, the website accessed by the hyperlink is likely to be a legitimate website with a niche following. However, the possibility still exists that this domain name was created to facilitate a phishing scam.

A low assigned page rank parameter for the identified domain name combined with a high assigned similarity parameter for the domain name indicates that the hyperlink is likely to be misleading 54. In this situation, there is little traffic to the website associated with the identified domain name and the identified domain name has a high similarity to a frequently visited domain name. Since the similarity parameter specifically looks for misleading characters inserted or omitted to make the domain name look like a well-known or high page rank domain name, this combination of low page rank parameter and high similarity parameter indicates a hyperlink that has a high likelihood of being a misleading link. By contrast, a low assigned page rank parameter for the domain name of the link destination combined with a low assigned similarity parameter for the domain name indicates that the hyperlink is possibly a good hyperlink 52.

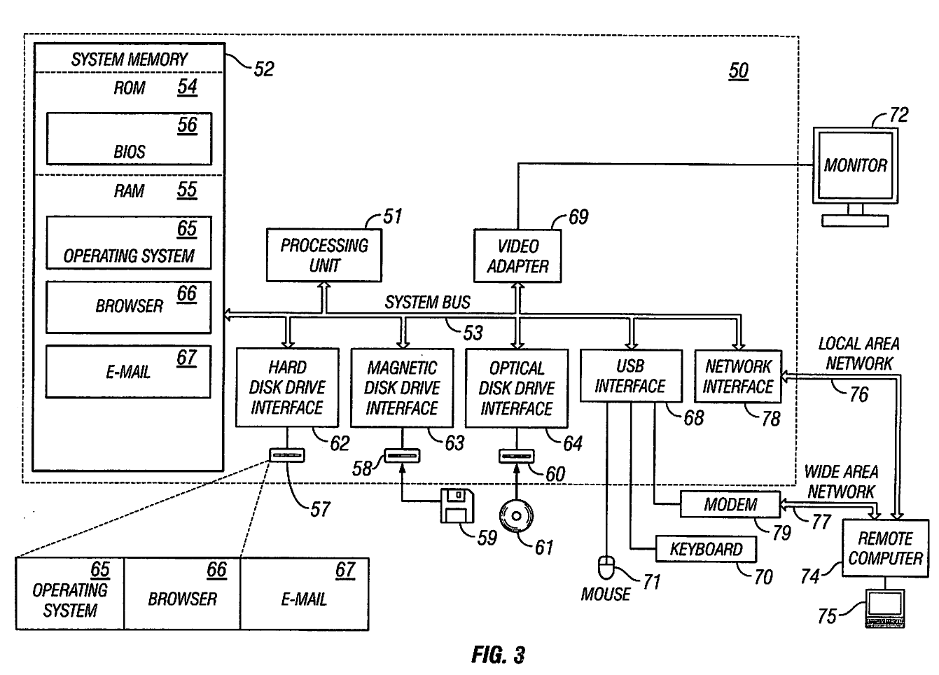

FIG. 3 is a schematic diagram of a computer system 50 that is capable of receiving and opening electronic documents, such as an email message, and performing a method of ensuring the validity of a URL link. The system 50 may be a general-purpose computing device in the form of a conventional personal computer 50. Generally, a personal computer 50 includes a processing unit 51, a system memory 52, and a system bus 53 that couples various system components including the system memory 52 to processing unit 51. System bus 53 may be any of several types of bus structures including a memory bus or memory controller, a peripheral bus, and a local bus using any of a variety of bus architectures. The system memory includes a read-only memory (ROM) 54 and random-access memory (RAM) 55. A basic input/output system (BIOS) 56, containing the basic routines that help to transfer information between elements within personal computer 50, such as during start-up, is stored in ROM 54.

Computer 50 further includes a hard disk drive 57 for reading from and writing to a hard disk 57, a magnetic disk drive 58 for reading from or writing to a removable magnetic disk 59, and an optical disk drive 60 for reading from or writing to a removable optical disk 61 such as a CD-ROM or other optical media. Hard disk drive 57, magnetic disk drive 58, and optical disk drive 60 are connected to system bus 53 by a hard disk drive interface 62, a magnetic disk drive interface 63, and an optical disk drive interface 64, respectively. Although the exemplary environment described herein employs hard disk 57, removable magnetic disk 59, and removable optical disk 61, it should be appreciated by those skilled in the art that other types of computer readable media which can store data that is accessible by a computer, such as magnetic cassettes, flash memory cards, digital video disks, Bernoulli cartridges, RAMs, ROMs, and the like, may also be used in the exemplary operating environment. The drives and their associated computer readable media provide nonvolatile storage of computer-executable instructions, data structures, program modules, and other data for computer 50. For example, the operating system 65 and application programs, such as a Web browser 66 and e-mail program 67, may be stored in the RAM 55 and/or hard disk 57 of the computer 50.

A user may enter commands and information into personal computer 50 through input devices, such as a keyboard 70 and a pointing device, such as a mouse 71. Other input devices (not shown) may include a microphone, joystick, game pad, satellite dish, scanner, or the like. These and other input devices are often connected to processing unit 51 through a serial port interface 68 that is coupled to the system bus 53, but input devices may be connected by other interfaces, such as a parallel port, game port, a universal serial bus (USB), or the like. A display device 72 may also be connected to system bus 53 via an interface, such as a video adapter 69. In addition to the monitor, personal computers typically include other peripheral output devices (not shown), such as speakers and printers.

The computer 50 may operate in a networked environment using logical connections to one or more remote computers 74. Remote computer 74 may be another personal computer, a server, a client, a router, a network PC, a peer device, a mainframe, a personal digital assistant, an Internet-connected mobile telephone or other common network node. While a remote computer 74 typically includes many or all of the elements described above relative to the computer 50, only a display device 75 has been illustrated in the figure. The logical connections depicted in the figure include a local area network (LAN) 76 and a wide area network (WAN) 77. Such networking environments are commonplace in offices, enterprise-wide computer networks, intranets, and the Internet.

When used in a LAN networking environment, the computer 50 is often connected to the local area network 76 through a network interface or adapter 78. When used in a WAN networking environment, the computer 50 typically includes a modem 79 or other means for establishing high-speed communications over WAN 77, such as the Internet. A modem 79, which may be internal or external, is connected to system bus 53 via serial port interface 68. In a networked environment, program modules depicted relative to personal computer 50, or portions thereof, may be stored in the remote memory storage device 75. It will be appreciated that the network connections shown are exemplary and other means of establishing a communications link between the computers may be used. A number of program modules may be stored on hard disk 57, magnetic disk 59, optical disk 61, ROM 54, or RAM 55, including an operating system 65 and browser 66.

The computer system described does not imply architectural limitations. For example, those skilled in the art will appreciate that the present invention may be implemented in other computer system configurations, including hand-held devices, multiprocessor systems, microprocessor based or programmable consumer electronics, network personal computers, minicomputers, mainframe computers, and the like. The invention may also be practiced in distributed computing environments, where tasks are performed by remote processing devices that are linked through a communications network. In a distributed computing environment, program modules may be located in both local and remote memory storage devices.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method comprising:
identifying a hyperlink within an electronic document, wherein the hyperlink includes a domain name; and
automatically taking remedial action against use of the hyperlink if the domain name is determined to be associated with a page rank value that is less than a threshold value and if the domain name is determined to have one or more misleading character substitution, addition, or deletion relative to another domain name that is associated with a page rank value greater than the threshold value.

2. The method of claim 1, wherein the domain name is determined to be associated with a page rank value that is less than a threshold value, by the steps of:
assigning a predetermined page rank value associated with the identified domain name if the identified domain name is present in a list of domain names having predetermined page rank values; and
assigning a page rank parameter as a function of the page rank value of the identified domain name and page rank values of domain names on the list if the identified domain name is not present in the list.

3. The method of claim 1, wherein the domain name is determined to have one or more misleading character substitution, addition, or deletion, by the steps of:
identifying differences between the identified domain name and at least one of the listed domain names; and
finding each of the identified differences in a list of misleading character substitutions, additions, and deletions.

4. The method of claim 3, wherein the identified domain name is determined to have one or more misleading character if the identified domain name would be match one of the listed domain names in the absence of the one or more misleading character substitution, addition, or deletion.

5. The method of claim 1, further comprising:
comparing the similarity of the link label to the identified domain name.

6. The method of claim 1, wherein the remedial action includes notifying the user that the hyperlink has a high likelihood of being misleading.

7. The method of claim 1, wherein the remedial action includes blocking the hyperlink.

8. The method of claim 3, wherein step of identifying differences further comprises:
identifying characters in the identified domain name which are in a different font or language than other characters in the domain name.

9. A computer program product including instructions embodied on a computer readable medium for determining the validity of a hyperlink, the instructions comprising:
instructions for identifying a hyperlink within an electronic document, wherein the hyperlink includes a domain name;
instructions for automatically taking remedial action against use of the hyperlink if the domain name is determined to be associated with a page rank value that is less than a threshold value and if the domain name is determined to have one or more misleading character substitution, addition, or deletion relative to another domain name that is associated with a page rank value greater than the threshold value.

10. The computer program product of claim 9, wherein the domain name is determined to be associated with a page rank value that is less than a threshold value, by the instructions further comprising:
instructions for assigning a predetermined page rank value associated with the identified domain name if the identified domain name is present in a list of domain names having predetermined page rank values; and
instructions for assigning a page rank parameter as a function of the page rank value for the identified domain name and a page rank value for domain names on the list if the identified domain name is not present in the list.

11. The computer program product of claim 9, wherein the domain name is determined to have one or more misleading character substitution, addition, or deletion, by the instructions further comprising:
instructions for identifying differences between the identified domain name and at least one of the listed domain names; and
instructions for finding each of the identified differences in a list of misleading character substitutions, additions, and deletions.

12. The computer program product of claim 11, wherein the identified domain name is determined to have one or more misleading character if the identified domain name would be match one of the listed domain names in the absence of the one or more misleading character substitution, addition, or deletion.

13. The computer program product of claim 9, further comprising:
instructions for comparing the similarity of the link label to the identified domain name.

14. The computer program product of claim 9, wherein the remedial action includes notifying the user that the hyperlink has a high likelihood of being misleading.

15. The computer program product of claim 9, wherein the remedial action includes
instructions for blocking the hyperlink.

16. The computer program product of claim 11, wherein the instructions for identifying differences further comprises:
instructions for identifying characters in the identified domain name which are in a different font or language than other characters in the domain name.
